(19) United States
(12) Patent Application Publication
(10) Pub. No.: US 2009/0033872 A1
(43) Pub. Date: Feb. 5, 2009

(54) Streaming lights

(76) Inventor: Herbert Jan Karl Boks, Alphen Pan Den Rijn (NL)

Correspondence Address: QUINN LAW GROUP, PLLC, 39555 ORCHARD HILL PLACE, SUITE # 520, NOVI, MI, 48375, US

(21) Appl. No.: 12/150,879

(22) Filed: May 1, 2008

Related U.S. Application Data
(60) Provisional application No. 60/924,211, filed on May 3, 2007.

(51) Int. Cl. G03B 21/32

(52) U.S. Cl. 352/40

(57) ABSTRACT

A method to create continuous motion using a plurality of images depicting numerous lines or pixels arranged in such a way as to create the perception of motion such as in a continuous flow, when projected in sequence, the sequence being repeated in an endless loop. The plurality of images can create a plurality of effects and can be embodied in many commercially viable ways: this can be a design projected on a full motion display, multi-layer edge lit, among many others.

### CROSS-REFERENCE TO RELATED APPLICATIONS

Listed below are patents of similar art and generally relating to the subject matter of the invention at hand:

U.S. Pat. No. 4,329,739

U.S. Pat. No. 5,321,593

U.S. Pat. No. 6,502,955

U.S. Pat. No. 6,527,412

U.S. Pat. No. 6,971,765

U.S. Pat. No. 7,114,829

U.S. Pat. No. 7,163,316

U.S. Pat. No. 7,186,016

2003/0046842

2006/0283116

### TRADEMARKS

‘Streaming Lights’ is a trademark of Estrakon Inc. 58 Parkland Plaza Ann Arbor, Mich. 48103. Other names used herein may be registered trademarks, trademarks or product names of Estrakon Inc. or other companies.

### BACKGROUND OF THE INVENTION

1. Field of the Invention

This invention relates to a method to use frames of images to create the illusion of continuous motion similar to the effect created by a movie or cartoon, but with the specific property that it only uses as little as three frames that are displayed in a continuous loop. This method can be used for decorative design articles and relates particularly to a manner decorative display or lighting for architectural light elements and/or commercial purposes.

2. Description of Background

Before the inventions of our method, various static patterns would simulate motion by various means. For instance, spirals would be spun to create the effect of concentric circles moving away from the viewer. Or lights on a display would be sequentially lit to create the effect of movement.

One embodiment was ‘chasing light’ lighting systems created either a static light effect or a ‘chasing light effect’ by which is meant the sequential electrification of light sources to create the effect of motion. The chasing light compositions generally required a lot of light sources, and therefore used a lot of power. Additionally, with such a vast plurality of light sources, the necessity for maintenance or to have the light sources changed.

Additionally, the plurality of light sources made the chasing light compositions limited in ability to be integrated into a space as an architectural element.

Another such embodiment is a system known as ‘Polar Motion” wherein the effect of motion was created by the uses of a device that used developed polarized film in a changeable shape that was then attached by a point on its surface to a mechanical device that would pivot or move to manipulate the light with varying shapes that were dark and light developed on the surface of the polar film. The effect of this device was awkward due to the nature of mechanical movement; furthermore the presence of moving parts was cumbersome and noisy, and required maintenance.

With advancements in technology and market demand over time, the need for a more advanced, versatile and visually pleasing design element is evident.

### SUMMARY OF THE INVENTION

The shortcomings of the prior art are overcome and additional advantages are provided through the provision of a method to use frames of images that simulate motion with as few as three images that are displayed successively and continuously looped.

The images can make a vast number of light effects; such as: the simulation of effervescing bubbles, steam, flowing water, rain, a swirl going in or out, a basket-weave effect, a star-burst effect with light streaming out from a point.

This method can be integrated into several embodiments. Two possible embodiments are: a multi-panel architectural figure, or a multi-panel edge-lit display with the images either as, the name or slogan of the company, or the afore mentioned method as the negative, or opposite disposition of the first embodiment. In the above embodiments, the images are etched on the surface, and are visible because of the total internal reflection principle. A third possible embodiment is a full-motion video display.

Specific articles and methods corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, the technical effect of the current invention is that it has achieved a solution which can perform the same function of several embodiments of light decoration such as ‘chasing lights’, but with a much more advanced technology which is flexible in form and creates the ability to create many more visual effects than the prior art. Additionally, we have created a solution that can be architecturally incorporated for uniform look; as well as, be used as a temporary addition to a space, which is a possible use of ‘chasing lights’ and similar technologies.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of an exploded view of a room design images incorporated with the articles of the current invention with detail of the corresponding articles relating to the current invention.

FIG. 2 illustrates one example of a sequential view of the above named embodiment, in which, the animation of motion is demonstrated.

FIG. 3 illustrates one example of a second embodiment of corresponding articles relating to the current invention incorporated in a commercial sign.

FIG. 4 illustrates one example of a third embodiment of corresponding articles relating to the current invention incorporated in a design element of a tile in a series of identical tiles.

The detailed description explains the preferred embodiments of the invention, together with advantages and features, by way of example with reference to the drawings.

### DETAILED DESCRIPTION OF THE INVENTION

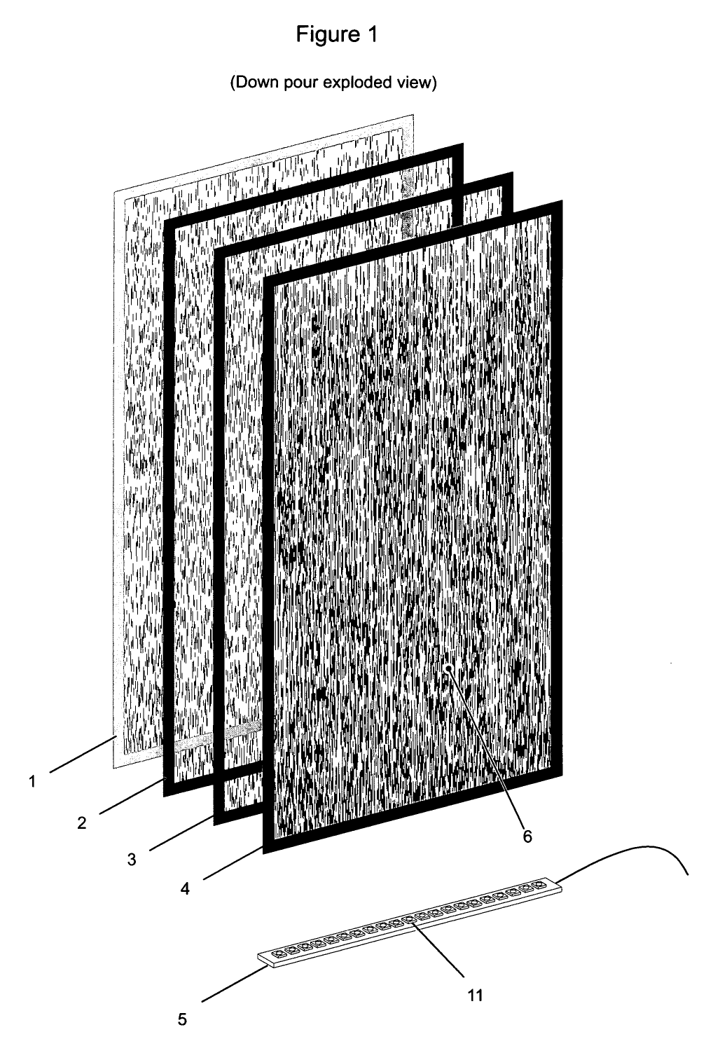

Turning now to the drawings in greater detail, it will be seen that in FIG. 1 there is an exploded view of a possible embodiment for the instant invention, wherein, the invention can be integrated as part of an architectural light element, such as a multi-layer edge-lit sign, having as many light sources (11) as it has panels (1-4) and is controlled by a micro controller (5). This embodiment could be used as a room separator or light the back of a bar or similar article.

The method (6) is evident of the surface of each panel (1-4); however, it is very limitedly visible when lit. The method (6) is made up of images (6a-g) may vary in shape and size depending on the requirements of the individual project; they can be pixels, lines or shapes. Panels (1-4) can be marked with these specific images on, in or adjacent to the panel surface. These images are applied in a manner so that they are diffusely reflective; thus, light contained with in the panel (1-4) is visible at the point of the etching because the irregular surface frustrates the totally internally reflected light in that area (1-4). Panels (1-4) can be constructed of material such as acrylic resin and must be transparent in order to facilitate the light effect. Each panel (1-4) can be printed slightly off-set from the one before or after it, in order to create the effect of the method (6) seemingly being random.

The above mentioned method (6) may consist of various shapes and sizes. The images (6a-g) within the method can be specularly-reflecting material and may be deposited on the surface of the panel in various manners including printing, etching into the surface of the panels or other similar processes.

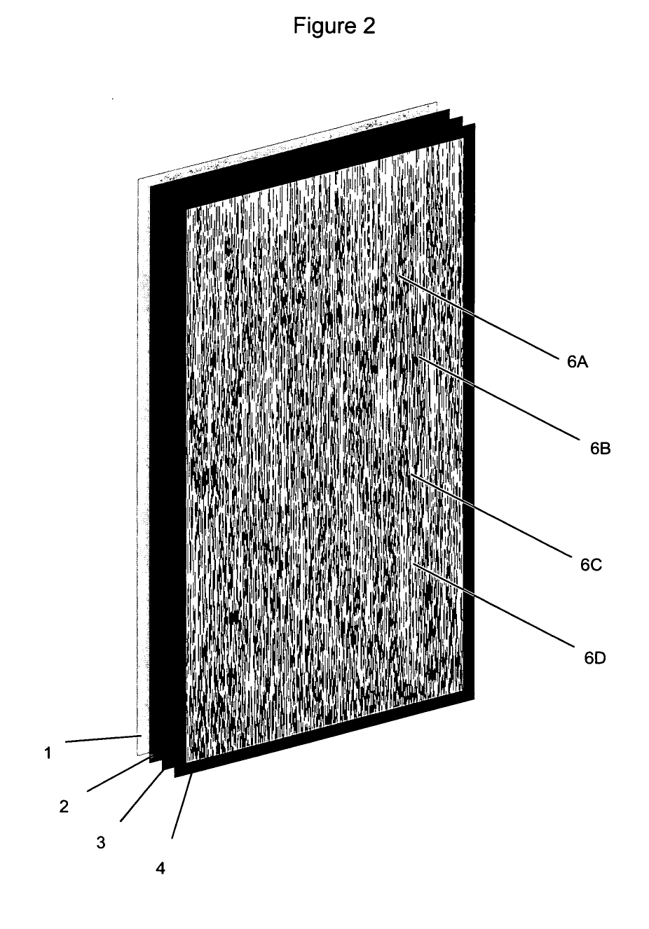

FIG. 2 demonstrates the stacked panels lit in sequence, thus creating the light effect of motion. The images with in the method (6a-g) work in such a way that one marking on each panel (1-4) lights sequentially and endlessly looping in the method to create light effect that is required. Specifically, in the embodiment shown, the markings are falling down and simulate the effect of rain fall, which is facilitated by the multi-layer panels (1-4), each of which has its own light source.

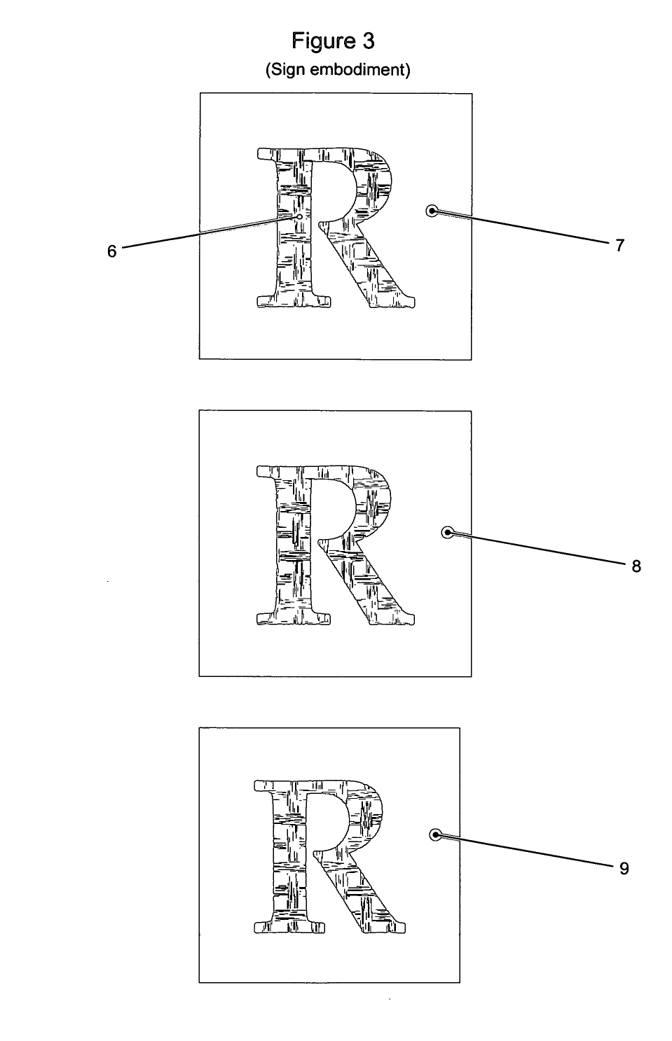

FIG. 3 Shows an second embodiment of this invention in which the images (6) are employed in a multi-layer edge-lit sign that has the pattern (6) rounding a curve. This embodiment is made with etched panels in order to create the effect. This creates the ability to have the images curve around in a specific and static way, which make the form of the letter always visible, while still allowing the motion of light within the panel. This is because of the ability of the etched surface to catch light even around a curve. The progression of the motion of the light within the panel is evident from the first panel (6) to the second panel (7), and finally, the third panel (8).

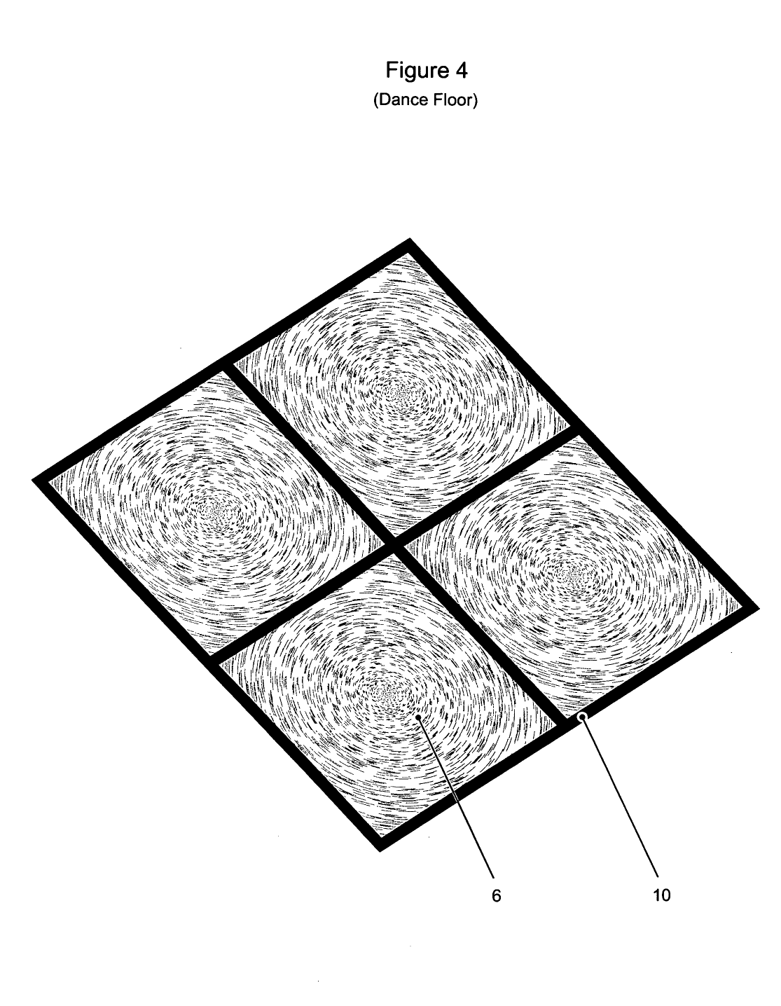

FIG. 4 shows a third embodiment of the current invention that demonstrates a tile (10) that can be used as a covering on any surface within a space. This embodiment show the images (6) creating the effect of a swirl descending into the tile (10). This effect is again achieved by etching the images into a multi-layer edge-lit display.

The present invention can be included in an article of manufacture having possible uses in many commercial fields and private applications in the art or education fields. The current invention can be included as a part of a larger composition, of similar or corresponding compositions, or sold separately.

The capabilities of the present invention can be implemented in specific articles of construction and methodology to create the light effect of animation. For instance, the steps may be performed in a differing order, or steps may be added, deleted or modified depending on the different requirements for the desired effect in relation to each individual project. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method to create a continuous motion by means of at least three successive frames that are continuously looped. The images on the frames are comprised of a plurality of images, arranged in a manner consistent with the intended motion either with or without obvious repetitive patterns.

2. The method of claim 1 wherein the figure consist of lines.

3. The method of claim 1 wherein the figure consist of pixels.

4. The method of claim 1 wherein the figure are graphic objects that moves freely on a display.

5. The method of claim 1 wherein the images is in an embodiment of a multi-layer, edge-lit sign.

6. The method of claim 1 wherein the images is in an embodiment of a design images incorporated on any surface of an architectural element.

7. The method of claim 6 wherein the image is in an embodiment of a light panel or a series of light panels on a wall.

8. The method of claim 6 wherein the images is in an embodiment of an internally lit floor panel or series internally lit floor panels located in or on a floor.
